(19) United States
(12) Patent Application Publication
(10) Pub. No.: US 2011/0007511 A1
(43) Pub. Date: Jan. 13, 2011

(54) Optically Transmissive Patterned Devices Formed of Fused Silica

(75) Inventor: James Bornhorst, DeSoto, TX (US)

Correspondence Address: Law Office of Scott C Harris Inc, PO Box 1389, Rancho Santa Fe, CA, 92067, US

(73) Assignee: PRODUCTION RESOURCE GROUP LLC, New Windsor, NY (US)

(21) Appl. No.: 12/832,721

(22) Filed: Jul. 8, 2010

Related U.S. Application Data
(60) Provisional application No. 61/224,438, filed on Jul. 9, 2009.

(51) Int. Cl. F21V 7/00; F21V 5/04

(52) U.S. Cl. 362/296.05; 362/311.01

(57) ABSTRACT

Optically transmissive patterned devices, such as gobos, formed on fused silica or more generally, on amorphous, non-crystalline substantially transparent silica containing structures. According to an embodiment, these are used with high power luminaires producing outputs greater than 1000 watts.

This application claims priority from Provisional application No. 61/224,438, filed Jul. 9, 2009, the entire contents of which are herewith incorporated by reference.

### BACKGROUND

Optically Transmissive and Patterned Devices such as gobos and dimmers are known for use in modern automated high-power luminaires. These devices are often put in the beam of light to alter the transmitted beam. Gobos have been formed of etched metal such as copper or aluminum. It has been suggested to form gobos of patterned borosilicate glass.

### SUMMARY

The present application describes use of optically transmissive patterned devices, such as gobos, formed on fused silica or more generally, on amorphous, non-crystalline substantially transparent silica containing structures. According to an embodiment, these are used with high power luminaires producing outputs greater than 1000 watts.

### BRIEF DESCRIPTION OF THE DRAWINGS

FIG. 1 shows a diagram of a remotely controlled luminaire system; and

FIGS. 2 and 3 show gobos on substrates according to embodiments.

### DETAILED DESCRIPTION

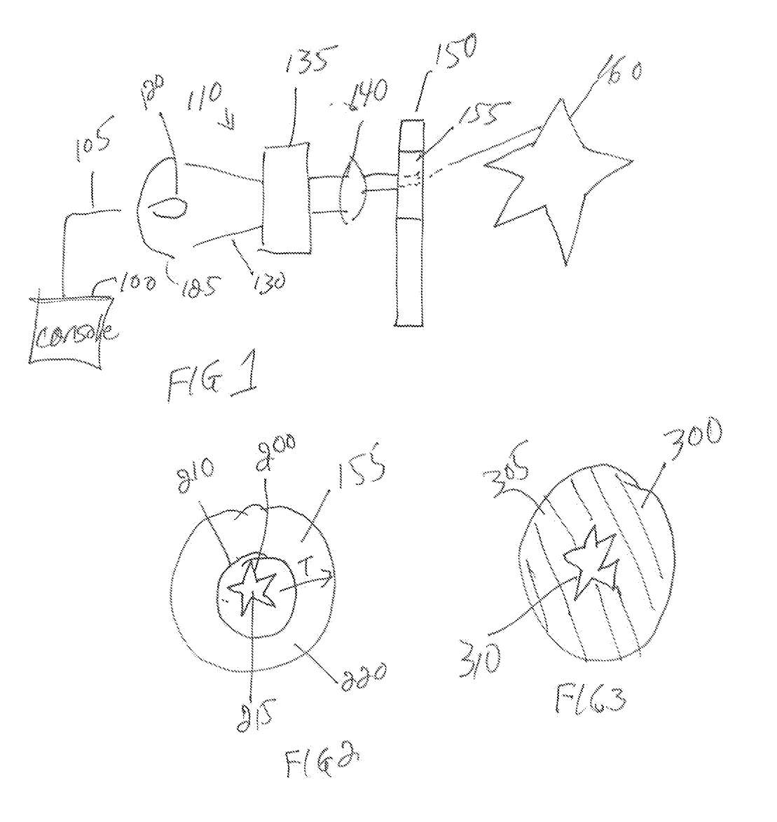

A block diagram of a high powered automated luminaire system is shown in FIG. 1. An operator at a console 100 produces command shown as 105 that controls characteristics of the luminaire 110. The luminaire 110 has a housing that may include a light source (lamp) 120 which typically outputs light having a high output amount, for example greater than 10000 lumen. The light from the source 120 is reflected by a spherical or parabolic reflector 125, and generally converges at 130 into optical system 135. The optical system 135 may include, for example, cold mirror and focusing optics. Additional focusing optics are shown as 140. An optically transmissive patterned device 150 may also be controlled by the console 105, and may be for example a gobo wheel, which includes a plurality of different gobos on wheels that rotate.

An example of a gobo wheel that can be used is described in our co-pending application Ser. No. 12/493,630, filed Jun. 29, 2009, the entire contents of which are herewith incorporated by reference.

150 shows a rotating gobo wheel, but it should be understood that this can be any kind of gobo device. The light passes through a position 155 on the gobo wheel, which in this embodiment may have a gobo in the shape of a star. The light beam 160 which is eventually projected has its outer shape altered by the gobo into the shape of a star. Different positions on the gobo wheel may have different shapes.

In another embodiment, a different optically transmissive patterned device can be used instead of 150. For example, this may be a patterned dimmer having dimming characteristics in a pattern such as shown in our co-pending application Ser. No. 12/493,330, the entire contents of which are herewith incorporated by reference.

In a luminaire of this type, optically transmissive patterned device 150, which can be a gobo wheel or a dimmer wheel, typically have a very high intensity light beam incident thereon. For example, the luminaire can have a light source with a power output greater than 1000 watts.

FIG. 2 illustrates the gobo 155, with its shape 200, and the light beam 210 incident on the shape. This beam is usually most intense at the center, and the energy per unit area falls off towards the beam edge. This high central intensity causes local heating in the center of the gobo. This heating, as found by the inventor, causes strain from expansion of the material of the gobo. The strain pushes outward towards from the hottest part 215 (the center) towards the cooler part 220. As the glass forming the substrate expands, the stresses rise in the glass, until the glass finally cracks to relieve itself of the stress.

Conventional borosiliate glass may crack in this situation to relieve its stress, especially in the situation where it is used with lamps which output high intensity. Hence, glass gobos often cannot be used in high wattage/high intensity lighting situations.

For example, a glass gobo is likely to fail when used with a luminaire that has a light source with a power output greater than 1000 watts, and conventionally has not been used for that reason.

The inventor found that the rate of expansion of temperature in a gobo or dimmer which uses transparent materials can cause failure in the materials. If the glass of the prior art was heated very slowly so that it could maintain an equal temperature throughout the entire glass, then all parts of the glass would expand at the same rate, and no mechanical stress would be introduced into the glass. However, in applications such as optically transmissive patterned devices such as gobos and dimmer wheels, the glass is heated in an uneven manner. In general, the light beam 210 impinges on a portion of the gobo 155 but not another portion, and is more intense in the center than at the edge. Large differences in temperature within the glass create different rates of expansion. These differing expansion rates cause mechanical strain which can build stresses to break the glass. This effect becomes even more pronounced when the gobo is subjected to a thermal shock such as when a cold glass gobo is rotated into a light beam quickly.

The inventors also recognize that since glass is a poor conductor of heat, the heat does not quickly spread from the center outward. This causes the thermal gradients across the glass radius to increase.

An embodiment is shown in FIG. 3, in which a gobo wheel or a gobo device is formed on the substrate of amorphous, non-crystalline substantially transparent silica containing material 300, e.g., fused quartz or fused silica. Fused silica is a non-crystalline form of silicone dioxide which is made by melting or fusing ultra pure silica sand (SiO2) in an electric arc furnace. Rod, tubing and sheet products are drawn from the viscous melt and cooled. This glass-like material has a very low coefficient of thermal expansion which makes it suitable for very high temperature use where other glasses either melt or crack. Typical fused silica has a Linear Coefficient of Thermal Expansion of about 0.55 E-6/° C. compared to other high temperature borosilicate glasses like Pyrex or Borofloat which are commonly used for gobos and dimmers. The linear temperature coefficients of the borosilicates are about 6 times greater than that of quartz glass, typically averaging around 3.25 E-6/° C.

Fused silica is a noncrystalline (glass) form of silicon dioxide (quartz, sand). Typical of glasses, it lacks long range order in its atomic structure. Its highly cross linked three dimensional structure gives rise to its high use temperature and low thermal expansion coefficient.

Key Properties of Fused Silica include:

Near zero thermal expansion

Exceptionally good thermal shock resistance

Very good chemical inertness

It can be lapped and polished to fine finishes

It has a low dielectric constant

It has a low dielectric loss

It has good UV transparency

Typical uses of fused silica include:

High temperature lamp envelopes

Temperature insensitive optical component supports

Lenses, mirrors in highly variable temperature regimes

Microwave and millimeter wave components

Aeronautical radar windows

High purity sand deposits provide the raw material for bulk refractory grade, which is electric arc melted at extremely high temperatures. Optical and general purpose fused silica rods and tubing are drawn from a melt made from high purity chemicals. Fiber optic purity is made by thermal decomposition of high purity gaseous silica containing chemicals. The glass may be clear or translucent, in which case it is often referred to as fused quartz. The glass has very high viscosity, and this property allows the glass to be formed, cooled and annealed without crystallizing. Fused silica glass is a very low thermal expansion material, and so is extremely thermal shock resistant. The material is also chemically inert up to moderate temperatures except to hydrofluoric acid, which dissolves silica. It will devitrify above about 1100° C. in the presence of contaminants such as sodium, phosphorus and vanadium, with the formation of cristobalite crystals which adversely effect the properties of the glass. The dielectric properties are stable up through gigahertz frequencies.

Fused silica is typically transparent or semitransparent to light, thereby allowing the light to pass through it. However, another important feature of fused silica is its thermal conductivity. Thermal Conductivity is a measure of how quickly heat spreads through the material. Examples of good thermal conductors are metals like copper and aluminum. Poor conductors are insulators like asbestos and glass. In materials with poor thermal conductivity heat does not spread out and the thermal gradients tend to be high. Poor conductors are also harder to cool as the heat tends to stay trapped inside the material. Blowing air across the surface of poor conductors does not remove internal heat very effectively. Only the surface is cooled with internal heat migrating very slowly to the surface. Blowing cold air on a hot gobo can actually increase the chances of breakage. Fused silica has a good thermal conductivity.

The Thermal Conductivity of borosilicate glass is about 1.10 Watts/meter ° K while fused silica is 25% more effective in conducting heat with a Tc of about 1.38 Watts/meter ° K. Since quartz has the ability to spread the heat out quicker, the thermal stresses resulting from the lesser thermal gradient are much reduced. The quartz gobo or dimmer is also much easier to cool with forced air from a fan.

Additionally, since both gobos and dimmers are generally coated with a patterned optical coating providing high reflectivity to the light beam thereby ensuring the lowest temperatures, survival of the coating is paramount to the operation of the part in a luminaire. These reflective coatings are generally metallic in nature and therefore have a lower survival temperature than the glass substrate. It is of no use to have the glass of the dimmer or gobo survive breakage while the coating boils away. Since fused silica conducts heat so well, compared to borosilicate or other glasses, the temperature of the substrate and coating can be kept lower with the same amount of air flow. Fan noise is reduced and, most importantly, the coating will survive better on fused silica than on any other glass-like substrate. Lower operating temperatures because of enhanced thermal conductivity was a surprise benefit of moving to the fused silica material for dimmer and gobo substrate and justifies the additional cost of quartz.

In an embodiment, the substrate 300 of fused silica is covered with a covering 305 that leaves an open pattern 310 at one or more portions thereof. The pattern portion 305 is reflective to the light beam. The open portion 310 is fused silica. Since to the light beam is reflected, this may lower the temperature, and the good heat conductivity of fused silica also lowers the temperature.

The above has described the use of fused silica as a substrate, however, any transparent substrate with good thermal conductivity can be used in alternative embodiments.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other materials which have the properties, amorphous, non-crystalline substantially transparent silica containing structures can be used, preferably when they have a thermal

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A luminaire system comprising:
a luminaire housing;
a light source greater than 1000 watts creating a light beam along an optical path inside the housing; and
a patterned transparent element formed of anamorphous, non-crystalline substantially transparent silica containing material, said element patterned to have a first transparent portion with an perimeter shape defining a shape of light from said light beam to be passed, and a non-transparent portion which blocks light from passing.

2. A system as in claim 1, wherein said transparent element is formed of fused silica.

3. A system as in claim 1, wherein said patterned transparent element includes the transparent element covered with a reflective part, where said reflective part is in the shape that has said first transparent portion.

4. A method comprising:
using a light source greater than 1000 watts to create a light beam along an optical path inside a housing of a luminaire; and
placing a patterned transparent element formed of anamorphous, non-crystalline substantially transparent silica containing material in a path of said light beam greater than 1000 watts, said element patterned to have a first transparent portion with an perimeter shape defining a shape of light from said light beam to be passed, and a non-transparent portion which blocks light from passing; and
projecting a patterned beam of light using said element.

5. A method as in claim 4, wherein said transparent element is formed of fused silica.

6. A method as in claim 4, wherein said patterned transparent element includes the transparent element covered with a reflective part, where said reflective part is in the shape that has said first transparent portion.

7. A gobo system comprising:
a patterned transparent element formed of anamorphous, non-crystalline substantially transparent silica containing material, said element patterned to have a first transparent portion with an perimeter shape defining a shape of light from said light beam to be passed, and a non-transparent portion which blocks light from passing.

8. A gobo as in claim 7, wherein said transparent element is formed of fused silica.

9. A gobo as in claim 7, wherein said patterned transparent element includes the transparent element covered with a reflective part, where said reflective part is in the shape that has said first transparent portion.
